(19) United States
(12) Patent Application Publication
(10) Pub. No.: US 2009/0213135 A1
(43) Pub. Date: Aug. 27, 2009

(54) Providing color space conversion

(75) Inventor: Tomi Heinonen, Tampere (FI)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 12/380,195

(22) Filed: Feb. 25, 2009

Related U.S. Application Data
(60) Provisional application No. 61/067,316, filed on Feb. 26, 2008.

(51) Int. Cl. G09G 5/02

(52) U.S. Cl. 345/591

(57) ABSTRACT

A method for providing color space conversion is desribed. The method included receiving a graphics object. The graphics object includes at least a first component expressed in a first color space and a second component expressed in a second color space. The first color space is distinct from the second color space. The method also includes piece-wise converting the graphics object to generate output data expressed in a third color space. The first component and a second component may be received and combined to generate the graphics object prior to converting. Apparatus and computer readable media are also described.

### TECHNICAL FIELD

The exemplary and non-limiting embodiments of this invention relate generally to systems, methods, devices and computer programs adapted to process graphical and image data and, more specifically, to perform color conversions associated with encoding, composition and presentation, as non-limiting examples.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Various abbreviations that appear in the specification and/or in the drawing figures are defined as follows:
CMOS complementary metal-oxide-semiconductor
CCD charge-coupled device
DSP digital signal processor
HW hardware
ISP image signal processor
LCD liquid crystal display
LED light emitting diode
LUT lookup table
OLED organic light emitting diode
PDA personal digital assistant
RGB, red, green, blue
sRGB standard RGB
SW software
UI user interface
YUV luma, chrominance

Many devices are capable of producing colors, for example, mobile phones, PDAs, laptops, digital cameras, TVs, etc. Such devices may comprise input systems (e.g., cameras, illumination sensors, data interfaces, etc.) and output systems (e.g., LCD displays, decorative lights (e.g., LEDs), external displays, televisions displays, etc.), and are capable of producing and representing graphical and image-based content. This content can be represented using any one of various color spaces.

OLED LCDs are capable of displaying more colors than can be represented using conventional RGB-color coding. As a result, it is typically necessary to provide conversions between color spaces (e.g., from sRGB to OLED-LCD color space, etc). In a typical implementation, all content is maintained in sRGB (or Adobe® RGB), and the content is converted to a display or hard copy-specific color space during display refresh and/or printing. In the case of display refresh, the data processing needed for the conversion is required to operate in real time, thereby requiring an efficient implementation. For example, typical color processing requires a 3×3 matrix multiplication with offset addition, and the use of a non-linearization technique, such as one accomplished using LUTs.

Due to new display technologies (as well as camera technologies) the color processing requirements are becoming more complex and these types of data processing techniques may not be adequate.

What is needed are new data processing techniques that are capable of fast and efficient operation for color conversion and related operations.

### SUMMARY

The below summary section is intended to be merely exemplary and non-limiting.

The foregoing and other problems are overcome, and other advantages are realized, by the use of the exemplary embodiments of this invention.

An exemplary embodiment in accordance with this invention is a method for providing color space conversion. The method included receiving a graphics object. The graphics object includes at least a first component expressed in a first color space and a second component expressed in a second color space. The first color space is distinct/different from the second color space. The method also includes piece-wise converting the graphics object to generate output data expressed in a third color space.

A further exemplary embodiment in accordance with this invention is a computer readable medium encoded with a computer program executable by a processor to perform actions for providing color space conversion. The actions include receiving a graphics object includes a first component expressed in a first color space and a second component expressed in a second color space. The first color space is distinct from the second color space. Piece-wise converting the graphics object to generate output data expressed in a third color space is also included in the actions.

An additional exemplary embodiment in accordance with this invention is an apparatus for providing color space conversion. The apparatus includes an input configured to receive a graphics object. The graphics object includes a first component expressed in a first color space and a second component expressed in a second color space. The first color space is distinct from the second color space. The apparatus also includes a color converter configured to piece-wise convert the graphics object to generate output data expressed in a third color space.

A further exemplary embodiment in accordance with this invention is an apparatus for providing color space conversion. The apparatus includes input means for receiving a graphics object includes a first component expressed in a first color space and a second component expressed in a second color space. The first color space is distinct from the second color space. The apparatus also includes color converter means for piece-wise converting the graphics object to generate output data expressed in a third color space.

### BRIEF DESCRIPTION OF THE DRAWINGS

The foregoing and other aspects of exemplary embodiments of this invention are made more evident in the following Detailed Description, when read in conjunction with the attached Drawing Figures, wherein:

FIG. 1 is a simplified block diagram of one exemplary and non-limiting embodiment of a color processing chain.

FIG. 2 is a simplified block diagram of a typical color processing use case, where each display pipe includes a color processing unit.

FIG. 3 shows the use case of FIG. 2 when modified for a composition use case, where the number of color processing blocks depends on the number of composition pipes multiplied by the number of separate display units.

FIG. 4 is a simplified block diagram showing a generic graphics accelerator architecture, where color processing is implemented at an input as well as at an output.

FIG. 5 is a simplified block diagram showing an exemplary general color processing unit.

FIG. 6 is a simplified block diagram showing an exemplary ISP pipeline.

FIG. 7 is a simplified block diagram showing an exemplary video/still image decoder post-processing unit.

FIG. 8 is a simplified block diagram showing a display controller, constructed in accordance with the exemplary embodiments of this invention, to include a single color processing unit to process the output of multiple display/composition pipes.

FIG. 9 shows an example of piece-wise color processing.

FIG. 10 is a simplified block diagram showing the graphics accelerator architecture of FIG. 4 that is modified and enhanced in accordance with the exemplary embodiments of this invention.

FIG. 11 is a simplified block diagram of one exemplary and non-limiting embodiment of the color processing chain of FIG. 1 that is modified and enhanced in accordance with the exemplary embodiments of this invention.

FIG. 12 is a logic flow diagram that illustrates the operation of a method, and a result of execution of computer program instructions, in accordance with the exemplary embodiments of this invention.

FIG. 13 is a simplified block diagram of an exemplary electronic device that is suitable for use in practicing the exemplary embodiments of this invention.

FIG. 14 shows a more particularized block diagram of an exemplary user equipment such as that shown at FIG. 13.

FIG. 15 is a logic flow diagram that illustrates the operation of a second method, and a result of execution of computer program instructions, in accordance with exemplary embodiments of this invention.

### DETAILED DESCRIPTION

The exemplary embodiments of this invention provide techniques to enable color processing using a single HW pipeline, as opposed to the use of a plurality of HW pipelines. The exemplary embodiments may be implemented in, as non-limiting examples, a display system, as well as in a graphics system, and are also applicable to a graphics system wherein there is a separate composition engine. The exemplary embodiments apply as well to display systems that support composition and to hard-copy device such as printers.

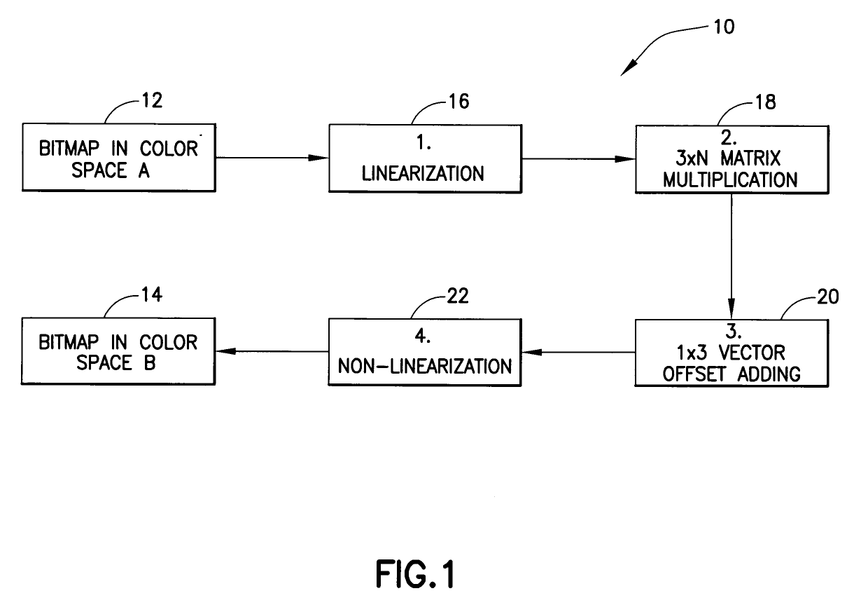

By way of introduction, a color space conversion procedure may be considered to generally follow the procedure outlined in FIG. 1. In the illustrated non-limiting example of a color processing chain 10 (which may also be referred to as a color processing pipe) there are four consecutive stages that operate in response to receiving a bitmap in color space A (input bitmap 12) to output a bit map in color space B (output bitmap 14). The color processing chain 10 includes, by example, a linearization stage 16, a (3×N) matrix multiplication stage 18, a (1×3 vector) offset addition stage 20 and a non-linearization stage 22. The linearization stage 16 may be implemented using look-up-tables, or by any other approach that is capable of meeting the processing performance (e.g., real-time or substantially real-time) needs. The offset addition stage 20 may be combined with the non-linearization stage 22. Depending on the needs of the color space conversion performed one or more of these stages may be omitted.

An aspect of color processing is an ability to achieve an acceptable (for the application of interest) accuracy for color depth and other calculations. For example, the accuracy should be better than 8-bits per color component (e.g., 16-bits per color component). This implies that the processing requirements are relatively demanding for real time applications (such as for a display refresh application), which further implies that a HW-based implementation can involve a considerable area of silicon in an integrated circuit, as well as memory for buffering various parameters and tables. In any integrated circuit-based implementation the total number of logic circuits needed, and the required die area, are important considerations.

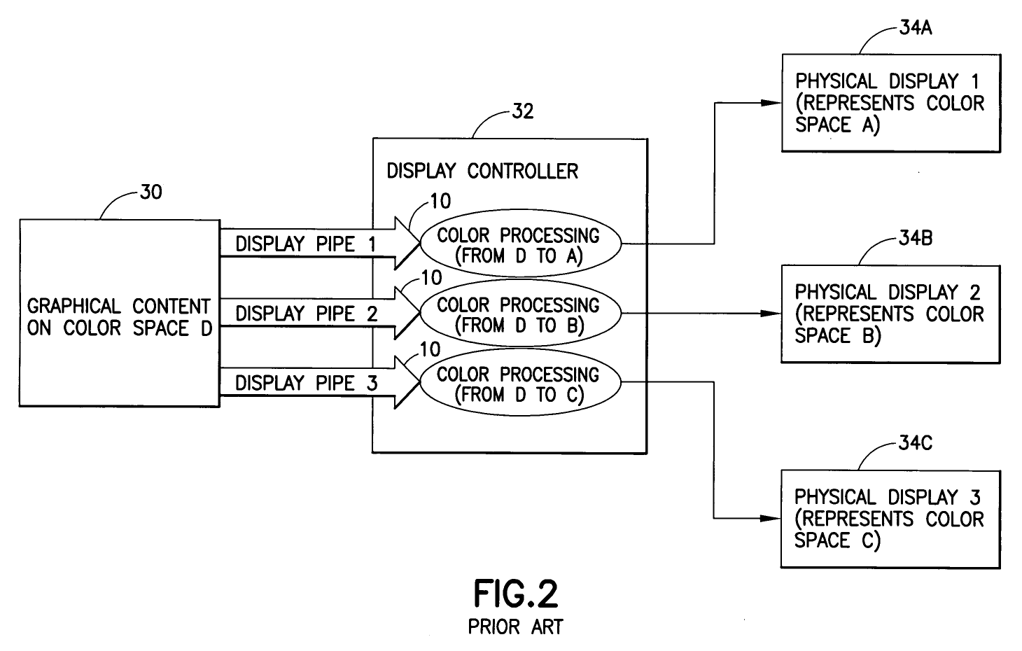

In addition, and referring to FIG. 2, current implementations that are known to the inventor require as many copies of the HW color processing unit or pipe 10 (e.g., as in FIG. 1) as there are separate output devices 34A, 34B, 34C. In this exemplary and non-limiting Figure it is assumed that there is one instance 30 of a graphical content in a color space D, and that a display controller 32 includes (in this example) three instances of the color processing pipe 10 performing color processing from color space D to color space A for physical display 34A (which represents color space A), from color space D to color space B for physical display 34B (which represents color space B) and from color space D to color space C for physical display 34C (which represents color space C).

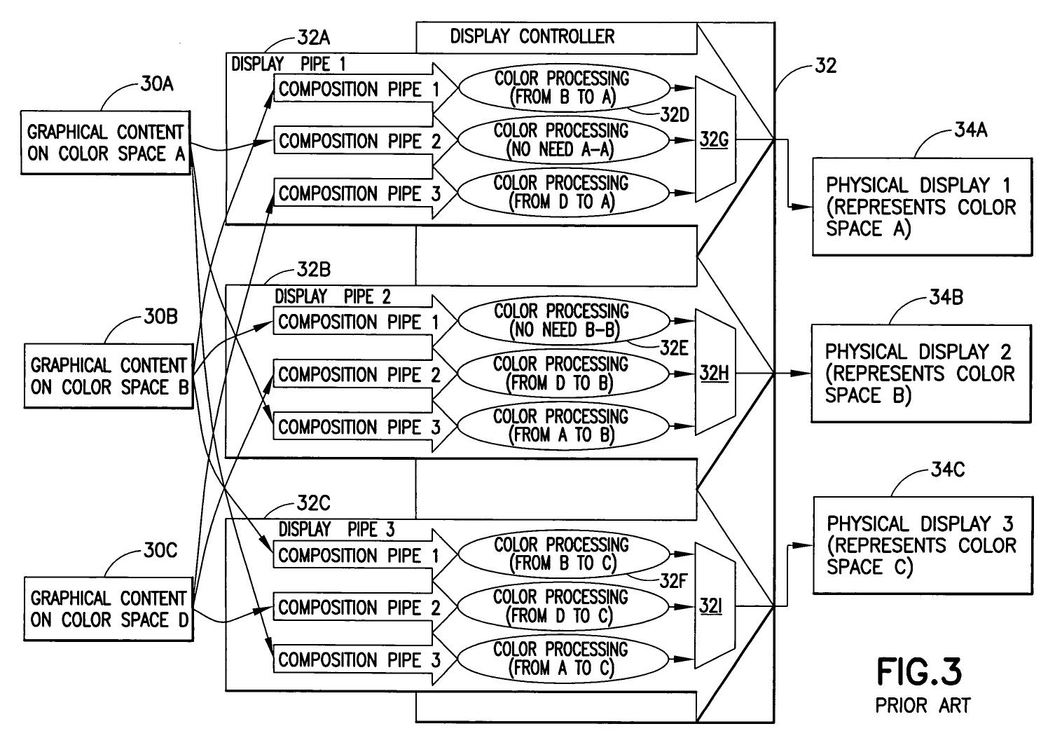

The procedure depicted in FIG. 2 can become more complex in the case of a composition (considered herein to be a combining of two or more graphical objects into one object). Referring to FIG. 3, in this example there are three instances 30A, 30B, 30C of the graphical content in color spaces A, B and D, respectively, providing inputs to three instances of display pipes 32A, 32B, 32C, each comprising three instances of sets of multi-composition pipes 32D, 32E, 32F. Each set of multi-composition pipes 32D, 32E, 32F provides its outputs to a combiner (32G, 32H, 32I, respectively) that provides the combined outputs (in the same color space A, B or C in this example) to the associated one of the displays 34A, 34B, 34C. This can represent, as a non-limiting example, the combining of user interface graphics (e.g., in color space A) with a video frame (e.g., in color space B) and with subtitles (e.g., in color space D). The display controller 32 in this use case includes three instances of the color processing HW in each display pipe, one for each of the exemplary three physical displays 34A, 34B and 34C. Notice in this example that certain of the composition pipes feed into color processing units where no color processing (color conversion) is needed, as when the input color space (e.g., 30B) matches the characteristics of the physical display (e.g., 34B).

The various procedure depicted in FIG. 2 may be implemented in hardware or special purpose circuits, software, logic or any combination thereof.

While color processing is clearly needed in the display system embodiments described in reference to FIGS. 2 and 3, it can be necessary as well in a graphics system. In general, current graphics accelerators that are known to the inventor do not include color processing features. However, if the “input textures” represent various color spacesuit can be advantageous to include color processing in the graphics system as well.

In general texture mapping, as well as bump mapping and displacement maps, are extensively used in computer graphics in order to achieve photorealistic renderings. In all these techniques, the mapping is typically one-to-one and every object surface location is assigned a single texture color, normal, or displacement. Other specialized techniques have also been developed for the rendering of supplementary surface details such as fur, hair, or scales.

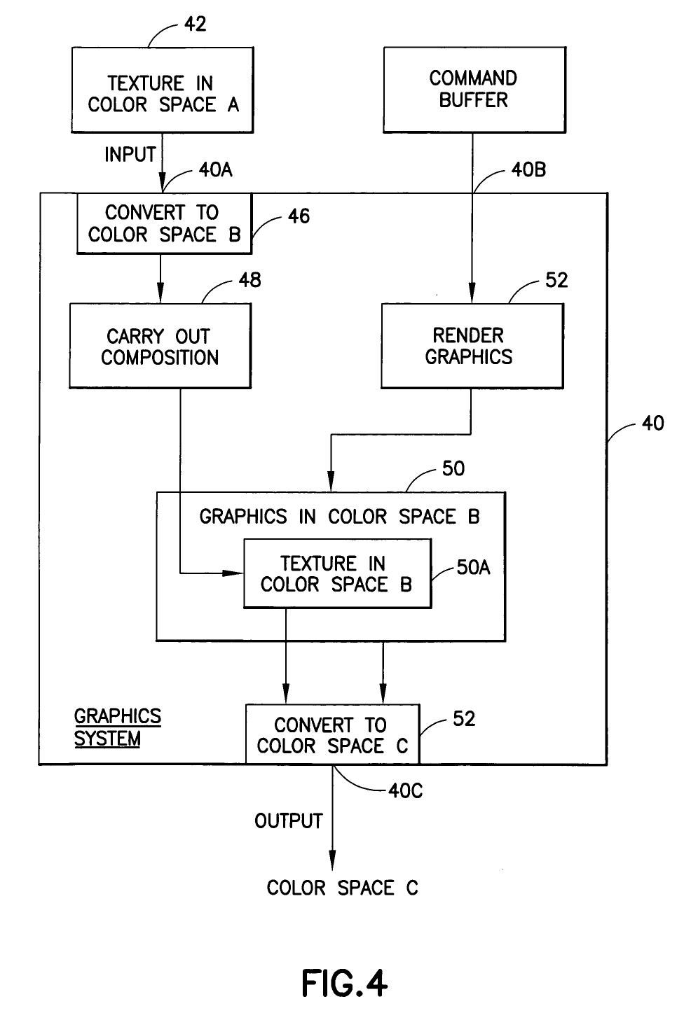

As a graphics accelerator device may not have the same real time operational requirements as a display system, it is possible that there may be only one color processing block at the input side (where each separate texture is processed when input to the graphics accelerator). The input color processing block may be integrated in the graphics accelerator, or it may be a separate module. The output of the graphics accelerator is preferably in some specific color space (such as sRGB or Adobe® RGB, which are currently target standards), and another color processing unit (e.g., color processing unit 52 of FIG. 4) may also be needed. The additional color processing unit may be a separate unit, or it may be integrated in the graphics system.

In FIG. 4 an exemplary and non-limiting embodiment of a graphics accelerator unit 40 has a first input 40A that receives a texture 42 in color space A, a second input 40B that receives a command from a command buffer 44, and an output 40C (note that other architecture/data flow models may also be used). The input 40A is connected with a first color space conversion unit 46 that converts the input texture from color space A to color space B. A composition unit 48 operates on the converted texture and provides an output to a unit 50 that executes a graphics operation in color space B. The execution unit includes the texture in color space B (50A), and operates with a graphics rendering unit 52 that responds to the graphics command received at input 40B. The output of unit 50 is applied to a second color space conversion unit 52 that converts the processed texture in color space B to a third color space, color space C, which is then applied to the output 40C.

In a further embodiment a graphics accelerator may include a separate composition unit which may support one or more input pipes. In this case the architecture may resemble that of the display system shown in FIG. 1, and may have as many input color processing units as there are input pipes.

In general there are at least three separate systems where multiple color processing units can be employed:
A. in a display controller and/or any display refresh system that is or is not capable of performing composition;
B. in a graphics accelerator that inputs textures of varying color spaces, and that outputs content in various color spaces; and
C. in a graphics system, where a composition system may be located in a separate module.

In addition to the foregoing, there are a number of other applications where color processing is useful. These applications include, but are not limited to, a general color processing unit, an ISP-pipeline, and a video/still image decoder post-processing unit.

More particularly, in the general color processing unit 60 shown in FIG. 5 there can be provided a HW/DSP/SW implementation that can be accessed by another processing entity. A bitmap is input in color space A, color conversion parameters are supplied to a color processing block 62, and the output is the converted bitmap in color space B. This is a very versatile solution, but increases memory load due to input and output memory access requirements. This type of system may be utilized, for example, with printing use cases.

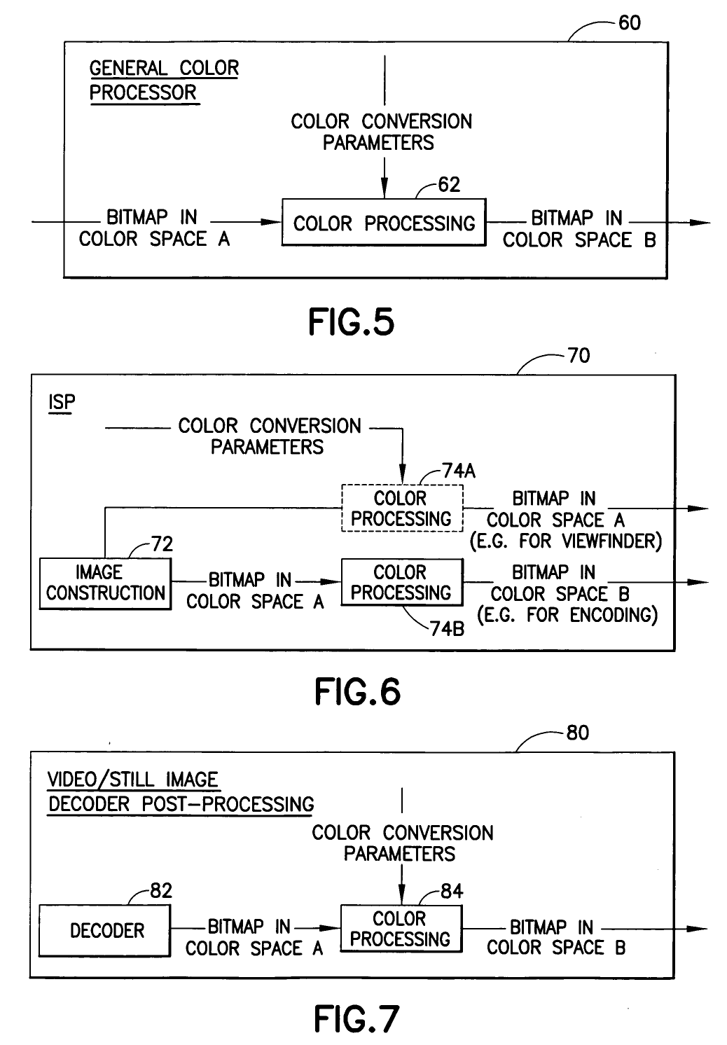

In the ISP pipeline 70 shown in FIG. 6 it is possible to reconstruct an image content directly to a particular color space, or there may be provided an additional color processing entity. This can be useful, for example, in an exemplary use case where a camera system viewfinder overlay is constructed in an ISP pipe in an appropriate color space with respect to a particular display device. In addition, overall image quality can be improved if necessary color conversions are carried out before additional scaling operations. In this embodiment there may be an image construction unit 72, and at least two separate color processing units 74A, 74B. As employed herein an ISP may be considered to be a unit adapted to process raw images from an image sensor, such as CCD/CMOS sensors, towards (for example) RGB or YUV images.

In the video/still image decoder post-processing embodiment 80 of FIG. 7, and in order to output video/still images in a display-dependent color space (e.g., supporting directly the display color space), color processing may need to be applied during a video/still image decoding post-processing operation. This embodiment includes a decoder 82, that produces a bitmap in color space A, followed by a suitable color processing block 84 that produces an output bitmap in color space B.

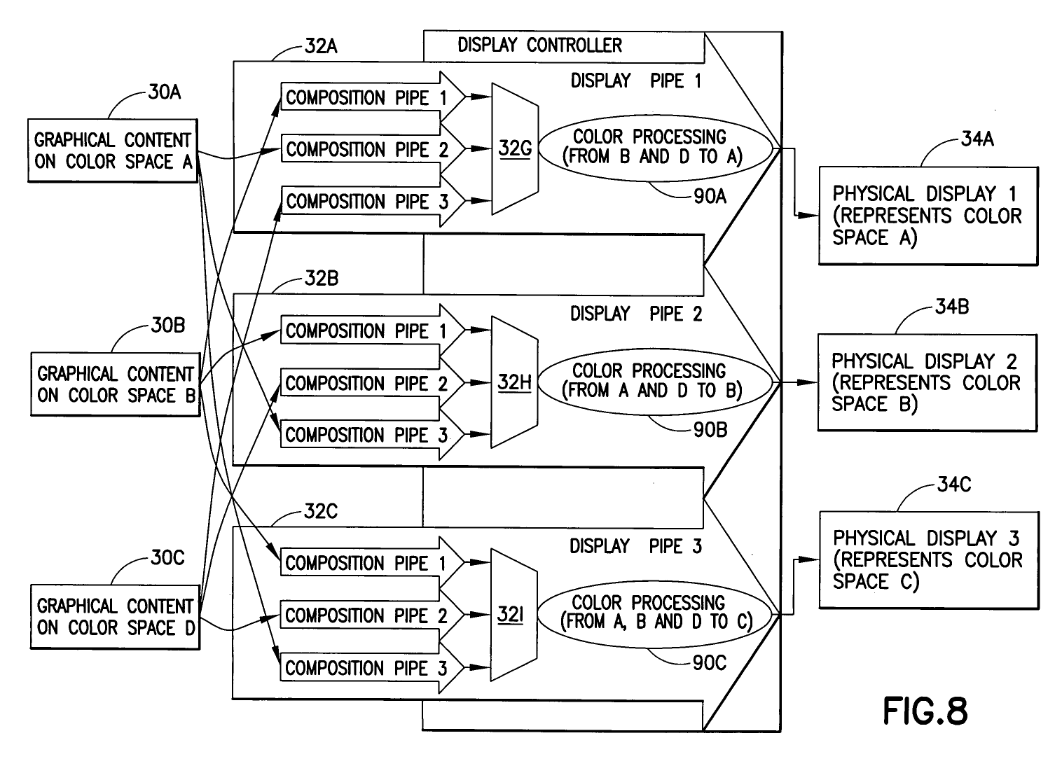

In accordance with the exemplary embodiments of this invention, as opposed to providing an input color processing unit for each pipe (as in FIG. 3), FIG. 8 shows an embodiment where there is provided a single output color processing unit or block 90A, 90B, 90C at the output of each combiner 32G, 32H, 32I, respectively, that processes the combined output of each associated set of display/composition pipes. In the illustrated example output color processing unit 90A converts combined content input data expressed in color spaces B and D to output data in color space A for use by display device 34A, output color processing unit 90B converts combined content input data expressed in color spaces A and D to output data in color space B for use by display device 34B, and output color processing unit 90C converts combined content input data expressed in color spaces A, B and D to output data in color space C for use by display device 34C.

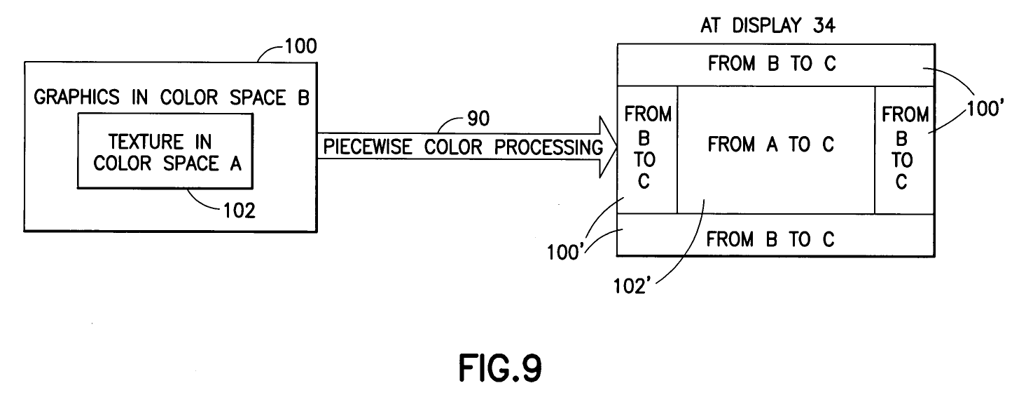

In order to enable this functionality each color processing block 90 supports piece-wise (or area-wise) color processing, as described in FIG. 9 (which shows the exemplary and non-limiting case of piece-wise processing from color spaces A and B to color space C). In the example of FIG. 9 the output of the combiner (e.g., 321) is comprised of a graphics object 100 expressed in color space B having a separate texture component 102 expressed in color space A. The output of the combiner is applied to the piece-wise color processing block 90 which operates on the data in each color space A and B to provide, at display 34, a corresponding graphics object 100′ and texture component 102′, both of which are expressed in color space C (the color space that is compatible with the display characteristics of the particular physical display 34, i.e., 34C in this non-limiting example).

The foregoing disclosed exemplary embodiments are not intended to be read as limiting in any way the number of supported color spaces, or the number or type of “pieces” that may be piece-wise processed in accordance with the invention.

In the exemplary embodiments of this invention the input data may be processed in any suitable manner, such as pixel-by-pixel (in any order) during display refresh, line-by-line, tile-by-tile, or rectangle-by-rectangle, as non-limiting examples. In the case of the improved display controller 32 shown in FIG. 8, the colors may be processed in the same order that the content is transferred from the display pipe to the display interface. In order to enable this type of piece-wise processing the composition system is assumed to support the following features.

First, the composition system is enabled to transfer composition information to the color processing unit 90. This composition information includes at least start and end coordinates for composition surfaces that are expressed in the different color spaces.

Second, the color processing unit 90 is assumed to store, or at least have access to, all necessary color conversion parameters. In the case of transparent composition surfaces, it is possible to either utilize either bottom (underlying) or top (overlying) surface color space, or utilize a combination of top/bottom surface color space conversion in order to achieve a best possible outcome when using only one color conversion.

Third, the color processing unit 90 may be enabled to perform two of more consecutive color conversions during a single composition (e.g., first the bottom surface, then the top surface).

All of the above described enhancements found in the color processing unit 90 are also applicable to graphics accelerator implementations, and to separate composition environments.

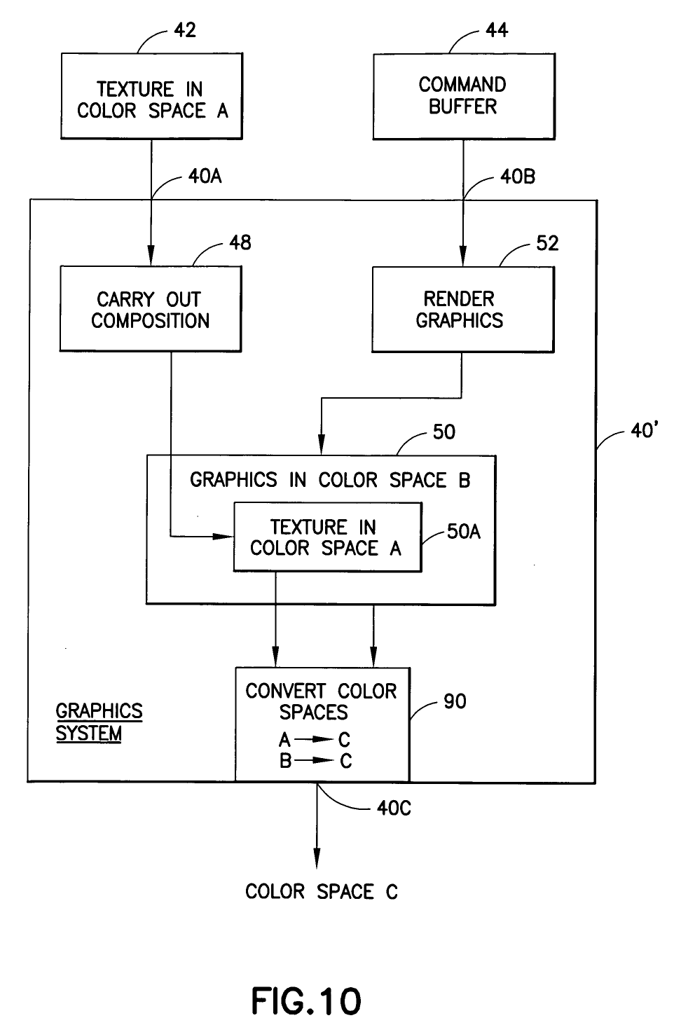

Further in this regard FIG. 10 shows a modification to the exemplary and non-limiting embodiment of the graphics accelerator 40 (designated as 40′) of FIG. 4, where the input first color space conversion unit 46 is removed, and where the composition unit 48 operates on input texture (e.g. color space A) and provides an output to a unit 50 that executes a graphics operation in color space B, with the texture still in color space A. The output of unit 50 is applied to the single color space conversion unit 90 that converts the processed texture in color space A, and the graphics in color space B, to the third color space C, which is then applied to the output 40C.

In general, the various embodiments of the graphics accelerator 40 may be implemented as parts of, but are not limited to, printers, scanners, software modules, display modules, camera modules, PDAs, GPUs, etc.)

In the case of texture rendering the graphics accelerator 40′ maintains information for the location of the texture in the overall graphics object. One approach may be to switch between color processing parameters when processing tiles (e.g., 4×4 arrays of pixels).

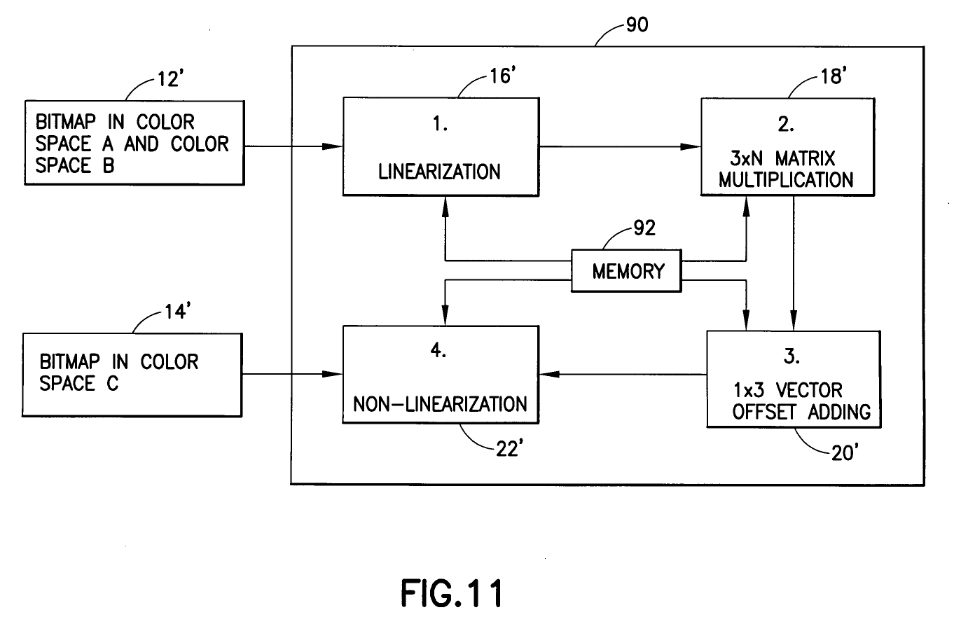

Based on the foregoing description it can be appreciated that an aspect of this invention is to provide, as shown in FIG. 11, a color processing pipeline 90 that may be equipped with memory 92 (e.g., cache memory) to store as many color space conversions parameters as are necessary (e.g., from A to C and from B to C). Alternatively, and depending on HW speed and efficiency, it may be possible to change the color parameters during color processing to accommodate the conversions from two or more color spaces to a target color space. In the illustrated non-limiting examples of the color processing pipeline 90 the four consecutive stages operate in response to receiving a bitmap in multiple color spaces (e.g., A and B) from the input bitmap 12′ to output the bit map 14′ in the single color space (e.g., color space C). The color processing pipeline 90 includes, by example, a linearization stage 16′, a (3×N) matrix multiplication stage 18′, a (1×3 vector) offset addition stage 20′ and a non-linearization stage 22′. These various stages differ from the stages shown in FIG. 1 in that each is programmable, depending on the contents of the memory 92, to perform operations needed for converting a current color space (e.g., A or B) to the selected output color space (e.g., C). As in the embodiment of FIG. 1, the linearization stage 16′ may be implemented using look-up-tables, and the offset addition stage 20′ may be combined with the non-linearization stage 22′. In addition, the linearization stage 16′ of the color processing pipeline 90 may be implemented in various manners in order to reduce memory requirements, such as by using curve fitting or piece-wise linear processing using sample points, as two non-limiting examples.

The color processing pipeline 90 is capable of recognizing the continuous regions that represent separate and distinct color spaces in the received bitmap. This may be accomplished in various manners, such as by providing a descriptive data structure separate from the color data to be converted, or by providing the descriptive data inline with the color data to be converted. Communication between the texture input block/composition input block and the color processing pipe may thus be provided, depending on the implementation.

In the case of the graphics system architecture (e.g. as shown in FIG. 10), the entire composition may be carried out piece-wise in an arbitrary order (no tearing problems). With the display system architecture (e.g., as shown in FIG. 8) the color processing is preferably performed pixel-by-pixel, or tile-by-tile, or line-by-line, etc., and the system is enabled to change the color processing parameters on the fly. This can be achieved, for example, by reloading the memory 92 with a new set of color processing parameters (e.g., over-writing the color processing parameters for color space A to color space C with new color processing parameters for color space B to color space C). Of course, if the memory capacity is adequate there may be no need to reload the color processing parameters.

The use of transparency (and opacity) may also be enabled, as described above.

Reference is made to FIG. 13 for illustrating a simplified block diagram of an exemplary electronic device and apparatus that is suitable for use in practicing exemplary embodiments in accordance with this invention.

In FIG. 13, an apparatus, such as a mobile communication device which may be referred to as a UE 1310, includes a controller, such as a computer or a data processor (DP) 1314, a computer-readable memory medium embodied as a memory (MEM) 1316 that stores a program of computer instructions (PROG) 1318, and a suitable radio frequency (RF) transceiver 1312 for bidirectional wireless communications with the eNB 1320 via one or more antennas.

The PROGs 1318 is assumed to include program instructions that, when executed by the associated DP, enable the device to operate in accordance with exemplary embodiments in accordance with this invention.

Exemplary embodiments in accordance with this invention may be implemented at least in part by computer software executable by the DP 1314 of the UE 1310, or by hardware, or by a combination of software and hardware (and firmware).

The UE 1310 may also include dedicated processors, for example, color space converter 1315.

In general, the various embodiments of the UE 1310 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The computer readable MEM 1316 may be of any type suitable to the local technical environment and may be implemented using any suitable data storage technology, such as semiconductor based memory devices, flash memory, magnetic memory devices and systems, optical memory devices and systems, fixed memory and removable memory. The DP 1314 may be of any type suitable to the local technical environment, and may include one or more of general purpose computers, special purpose computers, microprocessors, digital signal processors (DSPs) and processors based on a multicore processor architecture, as non-limiting examples.

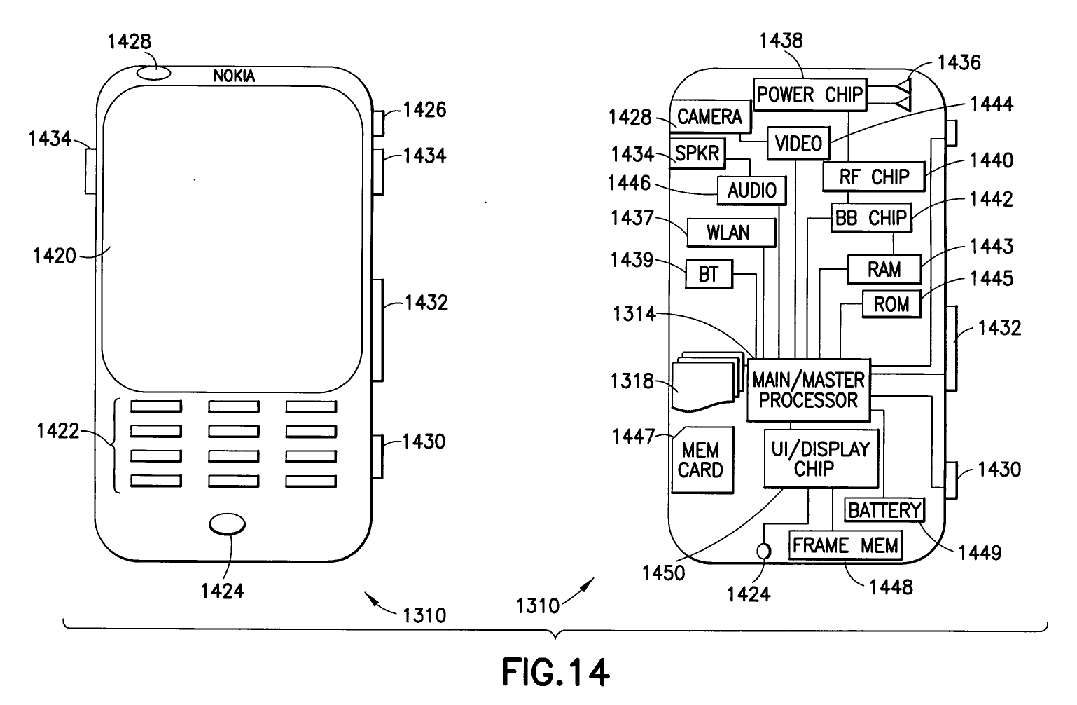

FIG. 14 illustrates further detail of an exemplary UE in both plan view (left) and sectional view (right), and the invention may be embodied in one or some combination of those more function-specific components. At FIG. 14 the UE 1310 has a graphical display interface 1420 and a user interface 1422 illustrated as a keypad but understood as also encompassing touch-screen technology at the graphical display interface 1420 and voice-recognition technology received at the microphone 1424. A power actuator 1426 controls the device being turned on and off by the user. The exemplary UE 1310 may have a camera 1428 which is shown as being forward facing (e.g., for video calls) but may alternatively or additionally be rearward facing (e.g., for capturing images and video for local storage). The camera 1428 is controlled by a shutter actuator 1430 and optionally by a zoom actuator 1432 which may alternatively function as a volume adjustment for the speaker(s) 1434 when the camera 1428 is not in an active mode.

Within the sectional view of FIG. 14 are seen multiple transmit/receive antennas 1436 that are typically used for cellular communication. The antennas 1436 may be multi-band for use with other radios in the UE. The operable ground plane for the antennas 1436 is shown by shading as spanning the entire space enclosed by the UE housing though in some embodiments the ground plane may be limited to a smaller area, such as disposed on a printed wiring board on which the power chip 1438 is formed. The power chip 1438 controls power amplification on the channels being transmitted and/or across the antennas that transmit simultaneously where spatial diversity is used, and amplifies the received signals. The power chip 1438 outputs the amplified received signal to the radio-frequency (RF) chip 1440 which demodulates and downconverts the signal for baseband processing. The baseband (BB) chip 1442 detects the signal which is then converted to a bit-stream and finally decoded. Similar processing occurs in reverse for signals generated in the apparatus 1310 and transmitted from it.

Signals to and from the camera 1428 pass through an image/video processor 1444 which encodes and decodes the various image frames. A separate audio processor 1446 may also be present controlling signals to and from the speakers 1434 and the microphone 1424. The graphical display interface 1420 is refreshed from a frame memory 1448 as controlled by a user interface chip 1450 which may process signals to and from the display interface 1420 and/or additionally process user inputs from the keypad 1422 and elsewhere.

Certain embodiments of the UE 1310 may also include one or more secondary radios such as a wireless local area network radio WLAN 1437 and a Bluetooth® radio 1439, which may incorporate an antenna on-chip or be coupled to an off-chip antenna. Throughout the apparatus are various memories such as random access memory RAM 1443, read only memory ROM 1445, and in some embodiments removable memory such as the illustrated memory card 1447. The various programs 1318 are stored in one or more of these memories. All of these components within the UE 1310 may be powered by a portable power supply such as a battery 1449.

Processors 1438, 1440, 1442, 1444, 1446, 1450, if embodied as separate entities in a UE 1310, may operate in a slave relationship to the main processor 1314, which may then be in a master relationship to them. Embodiments of this invention are most relevant to the graphical display interface 1420 and/or the image/video processor 1444, though it is noted that other embodiments need not be disposed there but may be disposed across various chips and memories as shown or disposed within another processor that combines some of the functions described above for FIG. 14. Any or all of these various processors of FIG. 14 access one or more of the various memories, which may be on-chip with the processor or separate therefrom.

Note that the various chips (e.g., 1438, 1440, 1442, etc.) that were described above may be combined into a fewer number than described and, in a most compact case, may all be embodied physically within a single-chip.

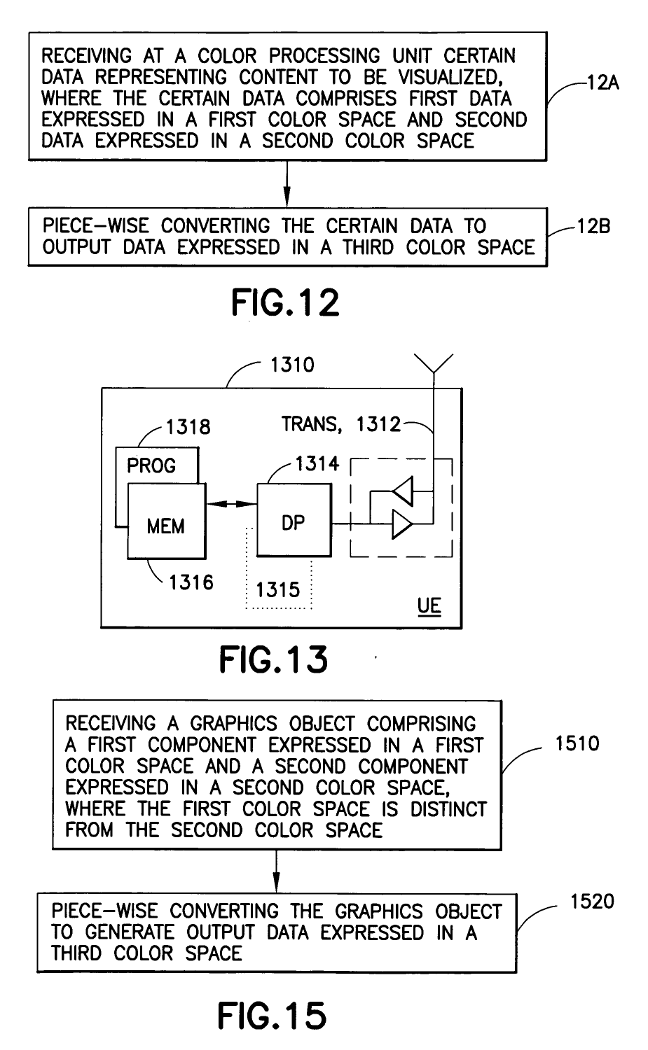

Based on the foregoing it should be apparent that the exemplary embodiments of this invention provide a method, apparatus and computer program product(s) to process graphics data. Referring to FIG. 12, a method includes (Block 12A) receiving at a color processing unit certain data representing content to be visualized, where the certain data comprises first data expressed in a first color space and second data expressed in a second color space; and (Block 12B) piece-wise converting the certain data to output data expressed in a third color space.

The method of the preceding paragraph, where at least one of the first and second data is texture data.

The method of the preceding paragraphs, further comprising providing the output data to one of a visual display device operable to display the output data or to a printer operable to print the output data.

The method of the preceding paragraphs, where the certain data is output from a combiner that combines the outputs of a plurality of graphical composition pipes, each operating on input data in one of a plurality of color spaces.

The method of the preceding paragraphs, where piece-wise converting includes the use of transparent composition surfaces.

The method of the preceding paragraphs, where piece-wise converting includes performing a plurality of consecutive color conversions during a single composition.

The method of the preceding paragraphs, where piece-wise converting is accomplished in at least one of a pixel-by-pixel basis, a line-by-line basis, a tile-by-tile, or a rectangle-by-rectangle basis, as non-limiting examples.

The method as shown in FIG. 12, where at least one of the first and second data is texture data, and where the output data is output from a graphics system.

FIG. 15 is a logic flow diagram that illustrates the operation of a second method, and a result of execution of computer program instructions, in accordance with exemplary embodiments of this invention. At block 1510, the method includes receiving a graphics object. The graphics object includes at least a first component expressed in a first color space and a second component expressed in a second color space. The first color space is distinct/different from the second color space. The method also includes piece-wise converting the graphics object to generate output data expressed in a third color space at block 1520.

The various blocks shown in FIGS. 12 and 15 may be viewed as method steps, and/or as operations that result from operation of computer program code, and/or as a plurality of coupled logic circuit elements constructed to carry out the associated function(s).

An exemplary embodiment in accordance with this invention is a method for providing color space conversion. The method included receiving a graphics object. The graphics object includes at least a first component expressed in a first color space and a second component expressed in a second color space. The first color space is distinct/different from the second color space. The method also includes piece-wise converting the graphics object to generate output data expressed in a third color space.

In an additional exemplary embodiment of the method above, one or more of the first component and the second component is visual content.

In a further exemplary embodiment of any one of the methods above, the method also includes providing the output data to one of a visual display device, a frame buffer or to a printer.

In an additional exemplary embodiment of any one of the methods above, the method also includes receiving a plurality of graphic data via a plurality of graphical composition pipes, where each pipe provides graphic data expressed in one of a plurality of color spaces. Combining the plurality of graphic data to generate the graphics object is also included.

In a further exemplary embodiment of any one of the methods above, converting includes using transparent composition surfaces.

In an additional exemplary embodiment of any one of the methods above, converting includes performing a plurality of consecutive color conversions during a single composition.

In a further exemplary embodiment of any one of the methods above, the method also includes determining a plurality of sub-regions of the graphics object, where an individual sub-region is expressed in an individual color space; and converting each sub-region to generate output sub-region data expressed in a target color space. The output data includes the plurality of output sub-region data.

In an additional exemplary embodiment of any one of the methods above, converting is accomplished in one or more of a pixel-by-pixel basis, a line-by-line basis, a tile-by-tile and a rectangle-by-rectangle basis.

A further exemplary embodiment in accordance with this invention is a computer readable medium encoded with a computer program executable by a processor to perform actions for providing color space conversion. The actions include receiving a graphics object includes a first component expressed in a first color space and a second component expressed in a second color space. The first color space is distinct from the second color space. Piece-wise converting the graphics object to generate output data expressed in a third color space is also included in the actions.

In an additional exemplary embodiment of the computer readable medium above, the actions also include providing the output data to one of a visual display device, a frame buffer or to a printer.

In a further exemplary embodiment of any one of the computer readable media above, the actions further include receiving graphic data via a plurality of graphical composition pipes, where each pipe provides graphic data expressed in one of a plurality of color spaces; and combining the graphic data to generate the graphics object.

In an additional exemplary embodiment of any one of the computer readable media above, converting includes using transparent composition surfaces.

In a further exemplary embodiment of any one of the computer readable media above, converting includes performing a plurality of consecutive color conversions during a single composition.

In an additional exemplary embodiment of any one of the computer readable media above, converting includes performing a plurality of consecutive color conversions during a single composition.

In a further exemplary embodiment of any one of the computer readable media above, the actions also include determining a plurality of sub-regions of the graphics object, where an individual sub-region is expressed in an individual color space; and converting each sub-region to generate output sub-region data expressed in a target color space. The output data includes the plurality of output sub-region data.

In an additional exemplary embodiment of any one of the computer readable media above, converting is accomplished in one or more of a pixel-by-pixel basis, a line-by-line basis, a tile-by-tile and a rectangle-by-rectangle basis.

In a further exemplary embodiment of any one of the computer readable media above, one or more of the first component and the second component is visual content.

An additional exemplary embodiment in accordance with this invention is an apparatus for providing color space conversion. The apparatus includes an input configured to receive a graphics object. The graphics object includes a first component expressed in a first color space and a second component expressed in a second color space. The first color space is distinct from the second color space. The apparatus also includes a color converter configured to piece-wise convert the graphics object to generate output data expressed in a third color space.

In a further exemplary embodiment of the apparatus above, one or more of the first component and the second component is visual content.

In an additional exemplary embodiment of the apparatus above, the apparatus also includes one or more of a visual display device configured to display an image based on the output data and to a printer configured to print the image.

In a further exemplary embodiment of any one of the apparatus above, the apparatus also includes a combiner configured to receive a plurality of graphic data via a plurality of graphical composition pipes, where each pipe provides graphic data expressed in one of a plurality of color spaces; to combine the plurality of graphic data to generate the graphics object; and to provide the graphics object to the input.

In an additional exemplary embodiment of any one of the apparatus above, converting includes using transparent composition surfaces.

In a further exemplary embodiment of any one of the apparatus above, the color converter is also configured to determine a plurality of sub-regions of the graphics object, where an individual sub-region is expressed in an individual color space; and to convert each sub-region to generate output sub-region data expressed in a target color space when piece-wise converting the graphics object. The output data includes the plurality of output sub-region data.

In an additional exemplary embodiment of any one of the apparatus above, converting is accomplished in one or more of a pixel-by-pixel basis, a line-by-line basis, a tile-by-tile and a rectangle-by-rectangle basis.

In a further exemplary embodiment of any one of the apparatus above, the apparatus also includes a memory configured to store a plurality of color space conversion parameters. The color converter is also configured to convert the graphics object based at least in part on color space conversion parameters.

In an additional exemplary embodiment of any one of the apparatus above, the apparatus is embodied as a part of a cellular phone.

In a further exemplary embodiment of any one of the apparatus above, the apparatus also includes at least one of a camera, illumination sensors and a data interface (e.g., DVB-TV antenna, internet connection, etc.).

In an additional exemplary embodiment of any one of the apparatus above, converting includes performing a plurality of consecutive color conversions during a single composition.

A further exemplary embodiment in accordance with this invention is an apparatus for providing color space conversion. The apparatus includes input means for receiving a graphics object includes a first component expressed in a first color space and a second component expressed in a second color space. The first color space is distinct from the second color space. The apparatus also includes color converter means for piece-wise converting the graphics object to generate output data expressed in a third color space.

In an additional exemplary embodiment of the apparatus above, one or more of the first component and the second component is visual content.

In a further exemplary embodiment of the apparatus above, the apparatus also includes one or more of visual display device means for displaying an image based on the output data and printer means for printing the image.

In an additional exemplary embodiment of any one of the apparatus above, converting includes performing a plurality of consecutive color conversions during a single composition.

In a further exemplary embodiment of any one of the apparatus above, the apparatus also includes combining means for receiving a plurality of graphic data via a plurality of graphical composition pipes, where each pipe provides graphic data expressed in one of a plurality of color spaces; for combining the plurality of graphic data to generate the graphics object; and for providing the graphics object to the input.

In an additional exemplary embodiment of any one of the apparatus above, converting includes using transparent composition surfaces.

In a further exemplary embodiment of any one of the apparatus above, the color converter means is also for determining a plurality of sub-regions of the graphics object, where an individual sub-region is expressed in an individual color space; and for converting each sub-region to generate output sub-region data expressed in a target color space when piece-wise converting the graphics object. The output data includes the plurality of output sub-region data.

In an additional exemplary embodiment of any one of the apparatus above, converting is accomplished in one or more of a pixel-by-pixel basis, a line-by-line basis, a tile-by-tile and a rectangle-by-rectangle basis.

In a further exemplary embodiment of any one of the apparatus above, the apparatus also includes memory means for storing a plurality of color space conversion parameters. The color converter means is also configured to convert the graphics object based at least in part on color space conversion parameters.

In an additional exemplary embodiment of any one of the apparatus above, the apparatus is embodied as a part of a cellular phone.

In a further exemplary embodiment of any one of the apparatus above, the apparatus also includes at least one of a camera, illumination sensors and a data interface (e.g., DVB-TV antenna, internet connection, etc.).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the inventions may be practiced in various components such as integrated circuit chips and modules.

Various modifications and adaptations to the foregoing exemplary embodiments of this invention may become apparent to those skilled in the relevant arts in view of the foregoing description, when read in conjunction with the accompanying drawings. For example, the use of these embodiments is not restricted to operation with any particular maximum number of color spaces or with any particular pixel coding (e.g., YUV4:2:2, YUV4:2:0, RGB32, etc), or to just the various color spaces mentioned above (e.g., sRGB, Adobe® RGB and/or YUV). In addition, the exemplary embodiments may be used in any suitable type of user equipment, including mobile phones, PDAs, computers and the like, having any suitable type and number of graphics/image presentation devices, such as display screens, projection units, hardcopy devices, decorative illumination elements and the like. Furthermore, it should be appreciated that the color processing unit or chain shown in FIG. 11 is not limiting, as in some embodiments it may contain more or fewer functional units (e.g., in some embodiments it may contain simply a 3×3 matrix multiplication function). In addition, it should be appreciated that while the converted output data 14′ may be used for presentation purposes, it may be used for other purposes as well, such as during encoding or during composition, as non-limiting examples. However, any and all modifications will still fall within the scope of the non-limiting and exemplary embodiments of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method comprising:
receiving a graphics object comprising a first component expressed in a first color space and a second component expressed in a second color space,
where the first color space is distinct from the second color space; and
piece-wise converting the graphics object to generate output data expressed in a third color space.

2. The method of claim 1, where at least one of the first component and the second component is visual content.

3. The method of claim 1, further comprising providing the output data to one of a visual display device, a frame buffer or to a printer.

4. The method of claim 1, further comprising:
receiving a plurality of graphic data via a plurality of graphical composition pipes, where each pipe provides graphic data expressed in one of a plurality of color spaces; and
combining the plurality of graphic data to generate the graphics object.

5. The method of claim 1, where converting comprises using transparent composition surfaces.

6. The method of claim 1, where converting comprises performing a plurality of consecutive color conversions during a single composition.

7. The method of claim 1, where piece-wise converting comprises:
determining a plurality of sub-regions of the graphics object, where an individual sub-region is expressed in an individual color space; and
converting each sub-region to generate output sub-region data expressed in a target color space,
where the output data comprises the plurality of output sub-region data.

8. The method of claim 1, where converting is accomplished in at least one of a pixel-by-pixel basis, a line-by-line basis, a tile-by-tile and a rectangle-by-rectangle basis.

9. A computer readable medium tangibly encoded with a computer program executable by a processor to perform actions comprising:
receiving a graphics object comprising a first component expressed in a first color space and a second component expressed in a second color space,
where the first color space is distinct from the second color space; and
piece-wise converting the graphics object to generate output data expressed in a third color space.

10. The computer readable medium of claim 9, the actions further comprising providing the output data to one of a visual display device, a frame buffer or to a printer.

11. The computer readable medium of claim 9, the actions further comprising:
receiving graphic data via a plurality of graphical composition pipes, where each pipe provides graphic data expressed in one of a plurality of color spaces; and
combining the graphic data to generate the graphics object.

12. The computer readable medium of claim 9, where converting comprises using transparent composition surfaces.

13. The computer readable medium of claim 9, where converting comprises performing a plurality of consecutive color conversions during a single composition.

14. An apparatus comprising:
an input configured to receive a graphics object comprising a first component expressed in a first color space and a second component expressed in a second color space,
where the first color space is distinct from the second color space; and
a color converter configured to piece-wise convert the graphics object to generate output data expressed in a third color space.

15. The apparatus of claim 14, further comprising at least one of a visual display device configured to display an image based on the output data and to a printer configured to print the image.

16. The apparatus of claim 14, further comprising a combiner configured:
to receive a plurality of graphic data via a plurality of graphical composition pipes, where each pipe provides graphic data expressed in one of a plurality of color spaces;
to combine the plurality of graphic data to generate the graphics object; and
to provide the graphics object to the input

17. The apparatus of claim 14, further comprising a memory configured to store a plurality of color space conversion parameters,
where the color converter is configured to convert the graphics object based at least in part on color space conversion parameters.

18. The apparatus claim 14, where the apparatus comprises a part of a cellular phone.

19. An apparatus comprising:
input means for receiving a graphics object comprising a first component expressed in a first color space and a second component expressed in a second color space,
where the first color space is distinct from the second color space; and
color converter means for piece-wise converting the graphics object to generate output data expressed in a third color space.

20. The apparatus of claim 19, further comprising memory means for storing a plurality of color space conversion parameters,
where the color converter is configured to convert the graphics object based at least in part on color space conversion parameters.
